(19) United States
(12) Patent Application Publication
(10) Pub. No.: US 2011/0026959 A1
(43) Pub. Date: Feb. 3, 2011

(54) IMAGE FORMING APPARATUS AND AGITATION CONTROLLING METHOD

(75) Inventor: Satoshi Itaya, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/844,180

(22) Filed: Jul. 27, 2010

Related U.S. Application Data
(60) Provisional application No. 61/229,623, filed on Jul. 29, 2009.

(51) Int. Cl. G03G 15/08

(52) U.S. Cl. 399/53; 399/254

(57) ABSTRACT

According to one embodiment, an image forming apparatus includes: a developing device configured to store, on the inside, a developer containing a toner and a carrier and discharge a part of the stored developer; a supply unit configured to supply the developer to the developing device; a mixer arranged in the developing device and configured to rotate at first rotating speed or second rotating speed lower than the first rotating speed and agitate the developer; a number-of-sheets-information acquiring unit configured to acquire number-of-sheets information, which is information indicating a number of sheets output by execution of image output processing; a determining unit configured to determine, on the basis of the number-of-sheets information acquired by the number-of-sheets-information acquiring unit, whether the number of output sheets reaches a predetermined threshold; and an agitation control unit configured to switch, if the determining unit determines that the number of output sheets reaches the threshold, rotating speed of the mixer executed at the first rotating speed to the second rotating speed.

### CROSS-REFERENCE TO RELATED APPLICATION

This application is also based upon and claims the benefit of priority from U.S. provisional application 61/229,623, filed on Jul. 29, 2009; the entire contents of which are incorporated herein by reference.

### FIELD

Embodiments described herein relate generally to an image forming apparatus configured to discharge, while preparing a developer in a developing device, a part of the prepared developer.

### BACKGROUND

There is an image forming apparatus configured to discharge, while preparing a developer in a developing device, a part of the prepared developer. In the image forming apparatus, a new toner and a new carrier are supplied and a developer is prepared, whereby a new developer is supplied into the developing device. A part of the prepared developer is carried by a mixer and discharged out of the developing device. By including the configuration, the image forming apparatus can maintain performance of the developer in the developing device.

### BRIEF DESCRIPTION OF THE DRAWINGS

FIG. 1 is a longitudinal sectional view of the schematic configuration of an image forming apparatus according to a first embodiment;

FIG. 2 is a general perspective view of the schematic configuration of a developing device in the image forming apparatus according to the first embodiment;

FIG. 3 is a cross sectional view of the schematic configuration of the developing device in the image forming apparatus according to the first embodiment;

FIG. 4 is a functional block diagram in the image forming apparatus according to the first embodiment;

FIG. 5 is a longitudinal sectional view of the schematic configuration of the developing device in the image forming apparatus according to the first embodiment;

FIG. 6 is a diagram of a relation between a toner specific concentration difference and an image failure in the first embodiment;

FIG. 7 is a table of a relation between rotating speed of a mixer of the developing device and the toner specific concentration difference in the first embodiment;

FIG. 8 is a flowchart for explaining processing for switching to second rotating speed in the image forming apparatus according to the first embodiment;

FIG. 9 is a flowchart for explaining processing for switching to second rotating speed in an image forming apparatus according to a second embodiment;

FIG. 10 is a functional block diagram in an image forming apparatus according to a third embodiment;

FIG. 11 is a diagram of an example of a table that associates an average printing ratio and a threshold of the number of prints in the third embodiment;

FIG. 12 is a flowchart for explaining processing for switching to second rotating speed in the image forming apparatus according to the third embodiment;

FIG. 13 is a functional block diagram in an image forming apparatus according to a fourth embodiment;

FIG. 14 is a diagram of an example of a table that associates an average printing ratio and second agitation condition information in the fourth embodiment;

FIG. 15 is a flowchart of processing for switching to second rotating speed in the image forming apparatus according to the fourth embodiment;

FIG. 16 is a diagram of an example of a table that associates an average intermittence ratio and a threshold of the number of prints in another embodiment;

FIG. 17 is a diagram of an example of a table that associates humidity and the threshold of the number of prints in the other embodiment;

FIG. 18 is a diagram of an example of a table that associates an average intermittence ratio and second agitation condition information in the fourth embodiment;

FIG. 19 is a diagram of an example of a table that associates humidity and the second agitation condition information in the fourth embodiment; and

FIG. 20 is a diagram of an example of a table that associates an average printing ratio and the second agitation condition information in another embodiment.

### DETAILED DESCRIPTION

In general, according to a first embodiment, an image forming apparatus includes a developing device, a developer cartridge (equivalent to a supply unit), a mixer, a information acquiring unit, a determining unit, and an agitation control unit. The developing device stores, on the inside, a developer containing a toner and a carrier and discharges a part of the stored developer. The developer cartridge supplies the developer to the developing device. The mixer is arranged in the developing device and configured to rotate at first rotating speed or second rotating speed lower than the first rotating speed and agitate the developer. The information acquiring unit acquires information indicating the quantity of image output processing. The determining unit determines, on the basis of the number-of-sheets information acquired by the information acquiring unit, whether the quantity of image output processing reaches a predetermined threshold. The agitation control unit changes, if the determining unit determines that the number of output sheets reaches the threshold, rotating speed of the mixer executed at the first rotating speed to the second rotating speed.

Embodiments are explained below with reference to the accompanying drawings.

In first embodiment, a number-of-sheets information acquiring unit is described as an example of the information acquiring unit. The number-of-sheets information acquiring unit acquires number-of-sheets, which is information indicating the number of sheets output by execution of image output processing.

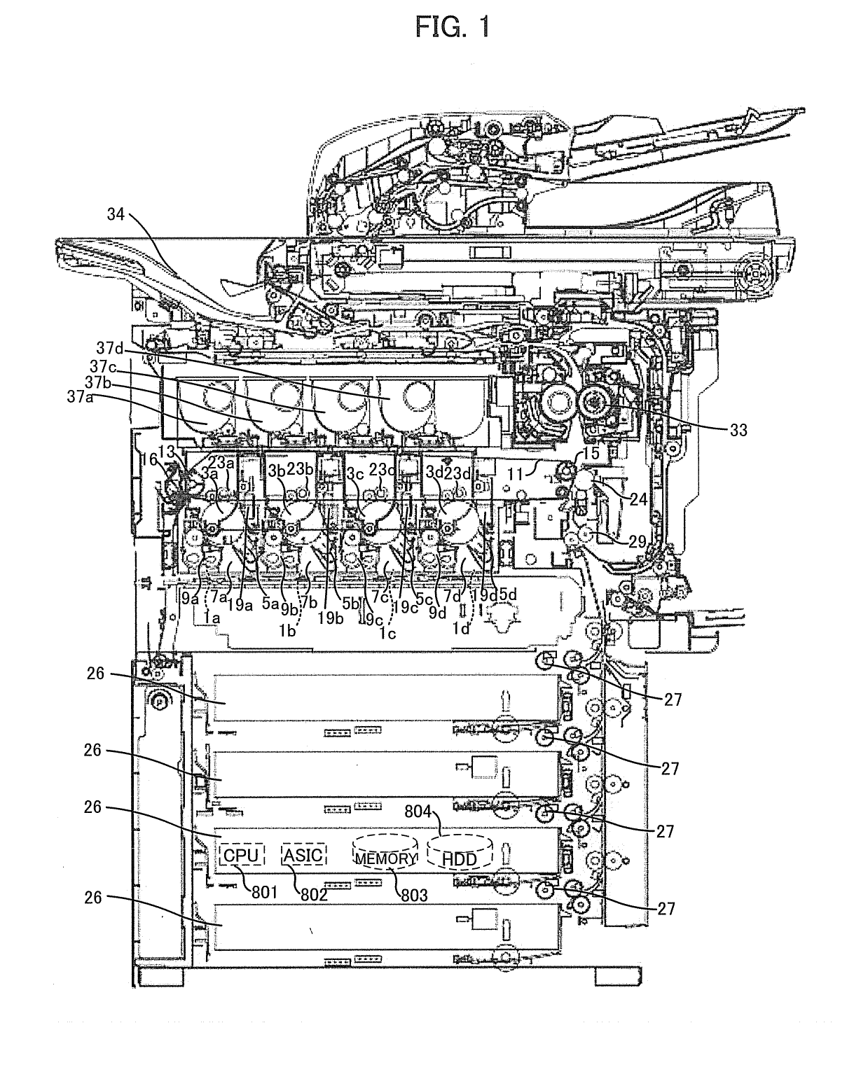

FIG. 1 is a longitudinal sectional view of the schematic configuration of an MFP (Multi Function Peripheral), which is an example of an image forming apparatus according to the first embodiment.

The MFP according to the first embodiment includes process units 1a, 1b, 1c, and 1d.

The process units 1a, 1b, 1c, and 1d respectively include photoconductive drums 3a, 3b, 3c, and 3d, which are image bearing members, and form developer images on the photoconductive drums.

The process unit 1a is explained as a representative example of the four process units 1a to 1d. The photoconductive drum 3a is formed in a cylindrical shape having a diameter of 60 mm and is provided to be rotatable in the clockwise direction in FIG. 1.

Devices explained below are arranged around the photoconductive drum 3a along the rotating direction. First, an electrifying charger 5a is provided to be opposed to the surface of the photoconductive drum 3a. The electrifying charger 5a uniformly charges a photoconductive surface of the photoconductive drum 3a negatively (−). An exposing device 7a configured to expose the charged photoconductive drum 3a to light and form an electrostatic latent image on the photoconductive drum 3a is provided on a downstream side in the photoconductive surface moving direction of the electrifying charger 5a. A developing device 9a configured to store an yellow developer and reversely develop the electrostatic latent image formed by the exposing device 7a with the developer is provided on the downstream side in the photoconductive surface moving direction of the exposing device 7a. A toner and a magnetic carrier are supplied to the developing device 9a from a developer cartridge 37a. An intermediate transfer belt 11, which is a medium on which an image is formed, is set in contact with the photoconductive surface of the photoconductive drum 3a.

A cleaner 19a is provided further on the downstream side than a contact position (so-called primary transfer position) of the photoconductive drum 3a and the belt 11. After transfer of a developer image onto the belt 11, the cleaner 19a removes surface charges of the photoconductive drum 3a with uniform light irradiation and, at the same time, removes and stores a residual toner on the photoconductive drum 3a.

Consequently, one cycle of image forming processing is completed. In the next image forming process, the electrifying charger 5a uniformly charges the un-charged photoconductive drum 3a again.

Specifically, the process unit 1a includes the photoconductive drum 3a, the electrifying charger 5a, the exposing device 7a, the developing device 9a, and the cleaner 19a.

The belt 11 has length (width) substantially equal to a length dimension of the photoconductive drum 3a in a direction (a depth direction in the figure) orthogonal to a sheet conveying direction (see a broken line arrow in FIG. 1). The belt 11 is an endless (seamless) belt. The belt 11 is wound and suspended around a driving roller 15 rotated at predetermined speed and several driven rollers (e.g., a roller 13).

On the belt 11, besides the process unit 1a, the process units 1b, 1c, and 1d are arranged between the driving roller 15 and the rollers 13 along a conveying direction of the belt 11.

All of the process units 1b, 1c, and 1d have configurations same as the configuration of the process unit 1a. Specifically, the photoconductive drums 3b, 3c, and 3d are respectively provided in substantially center positions of the process units 1b, 1c, and 1d. Electrifying charges 5b, 5c, and 5d are respectively provided around the photoconductive drums 3b, 3c, and 3d. Exposing devices 7b, 7c, and 7d are provided on downstream sides in photoconductive surface moving directions of the electrifying chargers. As in the configuration of the process unit 1a, developing devices 9b, 9c, and 9d and cleaners 19b, 19c, and 19d are provided downstream of the exposing devices.

The developing devices 9b to 9d store developers of colors different from the color of the developer stored in the developing device 9a. Specifically, the developing device 9b stores a magenta developer, the developing device 9c stores a cyan developer, and the developing device 9d stores a black developer.

The belt 11 sequentially comes into contact with the respective photoconductive drums 3a, 3b, 3c, and 3d.

Near contact positions of the belt and the photoconductive drums 3a, 3b, 3c, and 3d, transfer devices 23a, 23b, 23c, and 23d are provided to correspond to the respective photoconductive drums. The transfer devices 23 are arranged to be set in contact with the belt 11 on the back above the photoconductive drums corresponding to the transfer devices 23. The transfer devices 23 are opposed to the process units via the belt 11.

The transfer device 23a is connected to a not-shown DC power supply 25a of a plus pole (+) as a voltage applying device. Similarly, the transfer devices 23b, 23c, and 23d are respectively connected to DC power supplies 25b, 25c, and 25d also not shown in the figure.

In FIG. 1, the MFP includes paper feeding cassettes 26 configured to store sheets and pickup rollers 27 configured to pick up the sheets from the paper feeding cassettes 26 one by one. A registration roller pair 29 is rotatably provided near secondary transfer rollers. The registration roller pair 29 supplies, at predetermined timing, the sheet to a secondary transfer section where the secondary transfer rollers are opposed to each other across the belt.

The MFP includes a fixing device 33 configured to heat a developer transferred onto the sheet and fix the developer on the sheet and a paper discharge unit 34 to which a sheet subjected to fixing processing in the fixing device 33 is discharged.

The MFP according to the first embodiment further includes a CPU 801, an ASIC (Application Specific Integrated Circuit) 802, a memory 803, and a HDD (Hard Disk Drive) 804. The CPU 801 has a role of performing various kinds of processing in the MFP and has a role of realizing various functions by executing computer programs temporarily stored in the memory 803. It goes without saying that the CPU 801 can be replaced with an MPU (Micro Processing Unit) that can execute equivalent arithmetic processing. Similarly, the HDD 804 can be replaced with a storage device such as a flash memory.

The ASIC 802 is mounted with hardware (a circuit) configured to control various functions of the MFP.

The memory 803 can include, for example, a RAM (Random Access Memory), a ROM (Read Only Memory), a DRAM (Dynamic Random Access Memory), an SRAM (Static Random Access Memory), or a VRAM (Video RAM). The memory 803 has a role of temporarily storing various kinds of information and computer programs used in the MFP, log information of executed processing, and the like. For example, a computer program and data stored in the HDD 804 are read out to the memory 803 by the CPU 801. The CPU 801 executes processing using the computer program and the data read out to the memory 803. The CPU 801 causes the memory 803 to store information generated in a process of the processing such as log information of the processing and number-of-sheets information explained later.

A flow of an operation for outputting a color image onto a sheet is explained below as an example of processing for image output to a sheet in the MFP configured as explained above.

When the start of the image output processing is instructed, the photoconductive drum 3a receives driving force from a not-shown driving mechanism and starts rotation. The electrifying charger 5a uniformly charges the photoconductive surface of the photoconductive drum 3a. The exposing device 7a irradiates light corresponding to an image that should be recorded and forms an electrostatic latent image on the photoconductive surface of the photoconductive drum 3a uniformly charged by the electrifying charger 5a.

The developing device 9a stores a two-component developer containing an yellow (Y) toner and a magnetic carrier. The developing device 9a develops the electrostatic latent image with the yellow (Y) toner and forms an yellow toner image on the photoconductive drum 3a.

In a transfer area Ta formed by the photoconductive drum 3a, the belt 11, and the transfer device 23a, bias voltage is applied to the transfer device 23a. Consequently, a transfer electric field is formed between the transfer device 23a and the photoconductive drum 3a. The yellow toner image on the photoconductive drum 3a is transferred onto the belt 11 according to the transfer electric field.

The yellow (Y) toner image transferred onto the belt 11 in the transfer area Ta is carried to a transfer area Tb formed by the photoconductive drum 3b, the belt 11, and the transfer device 23b. In the transfer area Tb, a magenta toner image is transferred to be superimposed on the yellow toner image on the belt 11.

Subsequently, the toner images on the belt 11 are carried to a transfer area Tc formed by the photoconductive drum 3c, the belt 11, and the transfer device 23c. In the transfer area Tc, a cyan toner image is transferred to be superimposed on the toner images already transferred on the belt 11.

On the other hand, the pickup rollers 27 pick up a sheet from the paper feeding cassettes 26. The registration roller pair 29 supplies the sheet to the secondary transfer section.

In the secondary transfer section, predetermined bias voltage is applied to secondary transfer rollers 24. A transfer electric field is formed between the secondary transfer rollers 24 across the belt 11. The multiple color toner images on the belt 11 are collectively transferred onto the sheet.

In this way, the toner images of the respective colors collectively transferred onto the sheet are fixed on the sheet by the fixing device 33 and a color image is formed. The sheet subjected to fixing processing is discharged onto the paper discharge unit 34.

In the above explanation, an example in which a black toner image is not transferred onto the belt 11 (i.e., a color mode is executed by using process units that respectively store yellow, magenta, and cyan toners) is explained. However, the black toner image may be transferred onto the belt 11.

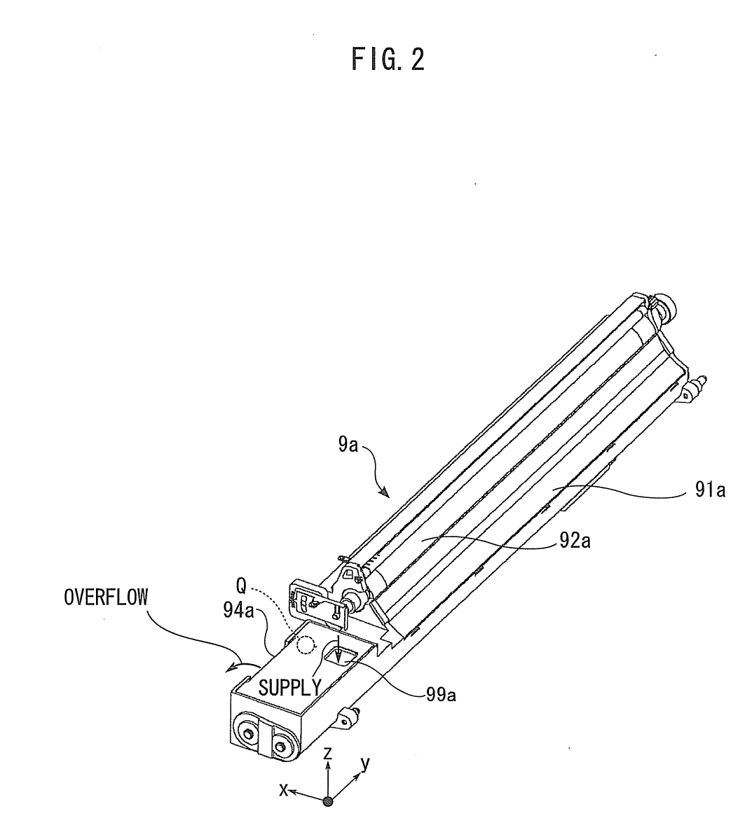

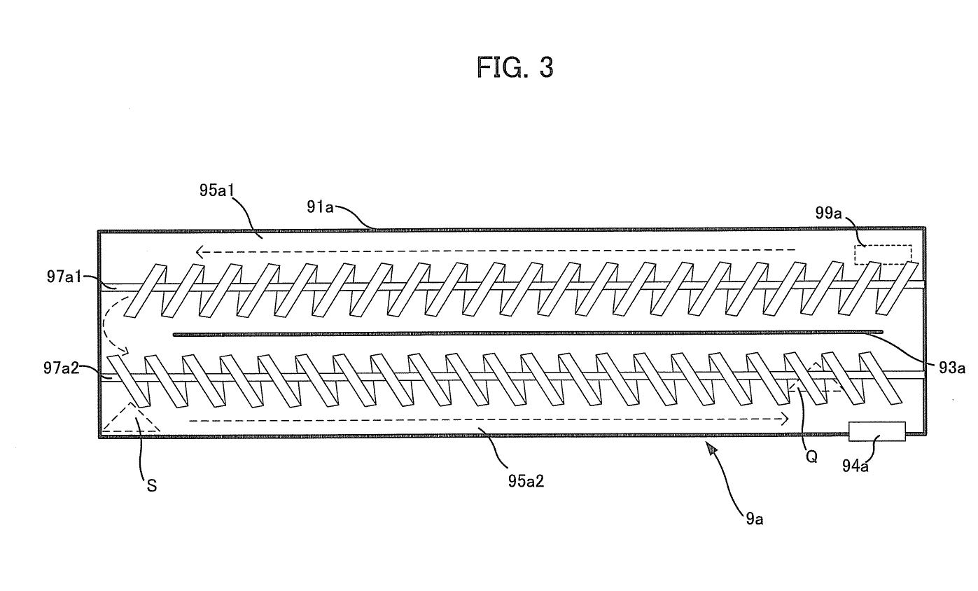

FIG. 2 is a general perspective view of the schematic configuration of the developing device 9a in the image forming apparatus according to the first embodiment. FIG. 3 is a cross sectional view of the schematic configuration of the developing device 9a in the image forming apparatus according to the first embodiment.

The developing device 9a includes a casing 91a as shown in FIG. 2. A carrying path shown in FIG. 3 for storing and carrying a developer is provided on the inside of the casing 91a. Specifically, on the inside of the developing device 9a, a first carrying path 95a1 and a second carrying path 95a2 are formed by a partition 93a provided along a longitudinal direction of the developing device. In the first carrying path 95a1 and the second carrying path 95a2, a mixer 97a1 and a mixer 97a2 are respectively arranged. The mixer 97a1 and the mixer 97a2 receive driving force from a not-shown motor and rotate at predetermined rotating speed.

In the casing 91a, a supply port 99a to which a toner and a carrier contained in a developer is input and a discharge port 94a from which the developer is discharged are provided. A toner density sensor Q is arranged near the discharge port 94a. Besides the toner density sensor Q, for example, a humidity sensor S may be arranged in the developing device 9a.

The developing device 9a includes a mug roller 92a arranged along the longitudinal direction of the developing device 9a and capable of coming into contact with the photoconductive drum 3a. The developer in the developing device 9a is supplied to the photoconductive drum 3a via the mug roller 92a. At this point, the mixer 97a1 and the mixer 97a2 in the developing device 9a rotate at first rotating speed explained later such that the developer is stably supplied to the mug roller 92a. An electrostatic latent image formed on the photoconductive surface of the photoconductive drum 3a is visualized by the developer supplied from the mug roller 92a and a developer image is formed. When the developer image is formed on the photoconductive drum 3a, toner density of the developer (the yellow toner) in the developing device 9a falls. Then, the toner density sensor Q detects the fall in the toner density in the developing device 9a. The yellow toner is input into the developing device 9a from the developer cartridge 37a via the supply port 99a provided in the casing 91a. The toner density in the developing device 9a is maintained constant. The carrier is input into the developing device 9a from the developer cartridge 37a via the supply port 99a simultaneously with the toner. In other words, the developer is input into the developing device 9a from the developer cartridge 37a. The input developer containing the toner and the carrier is carried through the first carrying path 95a1 and the second carrying path 95a2 in the developing device 9a as indicated by a broken line in FIG. 3 while being agitated by the rotation of the mixer 97a1 and the mixer 97a2. The developer overflows to be discharged from the discharge port 94a provided in the casing 91a by an amount of the developer input into the developing device 9a. Consequently, an amount of the developer in the developing device 9a is maintained constant and, at the same time, the old and deteriorated developer in the developing device 9a is replaced with a new developer little by little.

In the first embodiment, the mixer 97a1 and the mixer 97a2 respectively rotate at first rotating speed or second rotating speed. The second rotating speed is speed lower than the first rotating speed (explained in detail later).

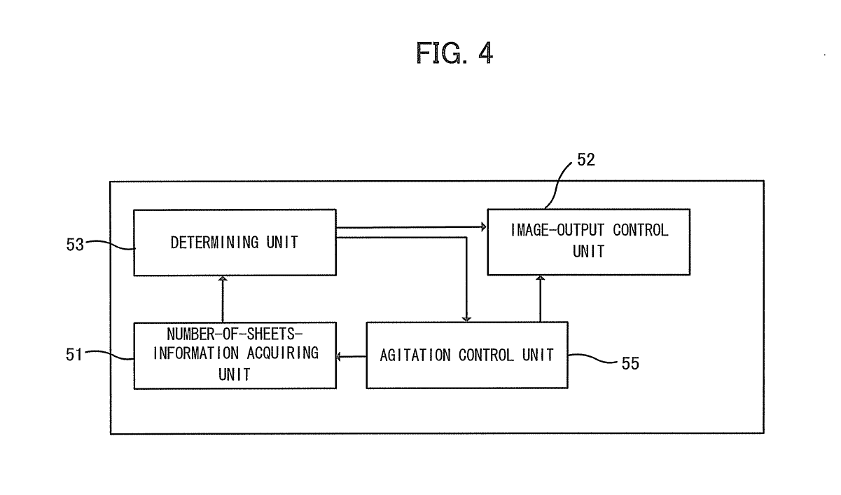

Functional blocks related to agitation control in the developing device according to the first embodiment are explained below with reference to FIG. 4.

As shown in FIG. 4, the MFP according to the first embodiment includes a number-of-sheets-information acquiring unit 51, a determining unit 53, an agitation control unit 55, and an image-output control unit 52.

The functional blocks can be realized by, for example, the CPU 801 executing a computer program read out to the memory 803.

The number-of-sheets-information acquiring unit 51 acquires number-of-sheets information, which is information indicating the number of sheets output by execution of processing for image output to a sheet after the last switching from the first rotating speed to the second rotating speed is executed concerning the developing device.

Specifically, the number-of-sheets-information acquiring unit 51 acquires, from log information concerning processing for image output to a sheet stored in the memory 803, information concerning the number of sheets output in the image output processing performed once. Subsequently, the number-of-sheets-information acquiring unit 51 acquires information indicating the number of sheets output in a job of the image output processing until the last time (hereinafter referred to as existing number-of-sheets information) stored in the memory 803 by the number-of-sheets-information acquiring unit 51. The number-of-sheets-information acquiring unit 51 generates new number-of-sheets information using the information concerning the number of sheets acquired from the log information and the existing number-of-sheets information to thereby acquire number-of-sheets information. The number-of-sheets-information acquiring unit 51 sends the number-of-sheets information acquired anew to the determining unit 53 and overwrites the existing number-of-sheets information using the number-of-sheets information acquired anew.

In some case, the existing number-of-sheets information is not stored in the memory 803. In this case, the number-of-sheets-information acquiring unit 51 generates number-of-sheets information from the information concerning the number of sheets acquired from the log information and causes the memory 803 to store the number-of-sheets information.

For example, it is assumed that the existing number-of-sheets-information indicating a counted number of sheets, i.e., eighty is stored in the memory 803 and the number-of-sheets-information acquiring unit 51 counts twenty-three as the number of sheets in a new job of the image output processing. In this case, the number-of-sheets-information acquiring unit 51 generates, on the basis of the number of sheets counted anew (twenty-three) and the existing number-of-sheets information (eighty), new number-of-sheets information indicating the number of counts (one hundred and three) obtained by totaling the number of sheets counted anew and the existing number-of-sheets information. The number-of-sheets-information acquiring unit 51 overwrites the existing number-of-sheets information (eighty) using the new number-of-sheets information (one hundred and three).

The determining unit 53 determines, on the basis of the number-of-sheets information acquired by the number-of-sheets-information acquiring unit 51, whether the number of output sheets reaches a threshold of the number of sheets. Specifically, first, the determining unit 53 acquires, according to acquisition of the number-of-sheets information, threshold information indicating a threshold of a counted number of sheets stored in the memory 803. Subsequently, the determining unit 53 determines, on the basis of the acquired number-of-sheets information and threshold information, whether the number of output sheets reaches the threshold of the number of sheets. If the determining unit 53 determines that the number of output sheets reaches the threshold of the number of sheets, the determining unit 53 notifies the agitation control unit 55 that the number of output sheets reaches the threshold of the number of sheets (the notification is hereinafter referred to as notification of a determination result).

In the first embodiment, the threshold information is readout from the HDD 804 to the memory 803 by the CPU 801 during the start of the MFP.

In the first embodiment, the determining unit 53 notifies the determination result to the image-output control unit 52 as well.

The image-output control unit 52 controls start timing of execution of the image output processing in the MFP. The image-output control unit 52 disables, execution of a new job of the processing for image output to a sheet until notification from the agitation control unit 55 is received on the basis of the acquisition of the notification of the determination result (explained in detail later). In other words, in the first embodiment, the rotation of the mixer at the second rotating speed is executed only when the processing for image output to a sheet is not performed.

If the determining unit 53 determines that the number of output sheets reaches the threshold, the agitation control unit 55 switches the rotating speed of the mixer in the developing device rotating at the first rotating speed to the second rotating speed.

Specifically, the agitation control unit 55 switches, according to the acquisition of the notification from the determining unit 53, the rotating speed of the mixer from the first rotating speed, which is normal carrying speed, to the second rotating speed on the basis of information concerning an operation condition of the mixer when the mixer is rotated at the second rotating speed stored in the memory 803 (hereinafter referred to as second agitation condition information).

Subsequently, the agitation control unit 55 switches, after rotating the mixer at the second rotating speed for a predetermined time on the basis of the second agitation condition information, the rotating speed from the second rotating speed to the first rotating speed. The agitation control unit 55 notifies the number-of-sheets-information acquiring unit 51 and the image-output control unit 52 that the rotating speed of the mixer is switched from the second rotating speed to the first rotating speed. The number-of-sheets-information acquiring unit 51 deletes, according to the notification from the agitation control unit 55, the number-of-sheets information stored in the memory 803 (reset of a counter). The image-output control unit 52 enables execution of a new job of the image output processing according to the notification from the agitation control unit 55.

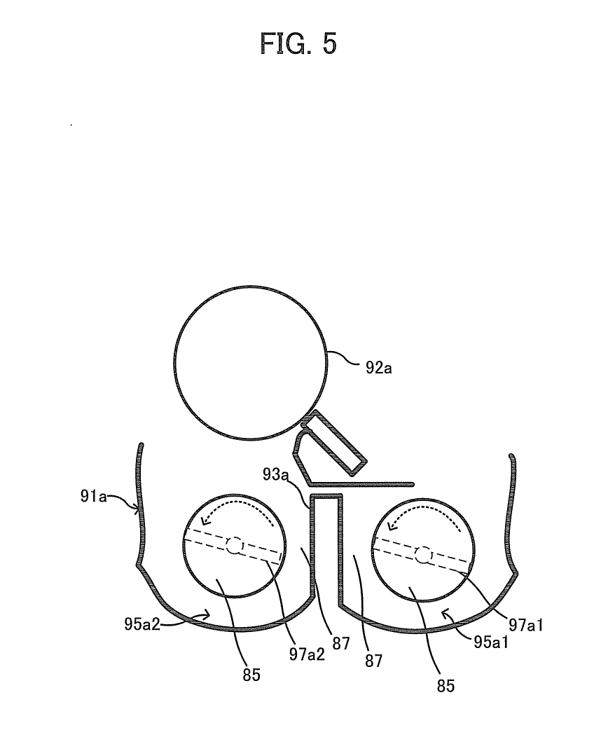

In the first embodiment, the first rotating speed is speed at which the MFP can display best productivity. More specifically, the first rotating speed is normal rotating speed of the mixer rotated when the image output processing is executed in the MFP and the developer is supplied according to the execution of the image output processing. The first rotating speed can be set by taking into account stability of carrying in the carrying path in the developing device, deterioration of the toner, and the like. FIG. 5 is a longitudinal sectional view of the schematic configuration of the developing device 9a in the image forming apparatus according to the first embodiment. For example, as shown in FIG. 5, rotating speed of the mixer 97a2 arranged on the second carrying path 95a2 opposed to the mug roller 92a is set to about 360 rpm. Rotating speed of the mixer 97a1 arranged on the first carrying path 95a1 communicating with the supply port 99a is set to about 510 rpm. In the first embodiment, the rotation of the mixer at the first rotating speed is controlled by the CPU 801 using information concerning an agitation condition at the first rotating speed (hereinafter referred to as first agitation condition information).

Concerning operation conditions at the time when the mixer is rotated at the second rotating speed indicated by the second agitation condition information, specific rotating speed and rotation time are desirably set such that, for example, when the toner and the carrier are supplied into the developing device under a condition that a weight ratio is 6:1, a toner specific concentration difference between a mixer agitating section and a developing device wall surface section is equal to or smaller than 2.55.

The toner specific concentration is a value representing a mixing ratio of the carrier and the toner. The mixer agitating section means an area with which a blade of the mixer comes into contact to directly agitate the developer. The developing device wall surface section means an area around the mixer agitating section and near an inner wall surface of the casing with which the blade of the mixer does not come into direct contact. In the developing device wall surface, unlike the mixer agitating section, the developer tends to be held up. To facilitate understanding, in FIG. 5, the mixer agitating section is represented as 85 and the developing device wall surface section is represented as 87.

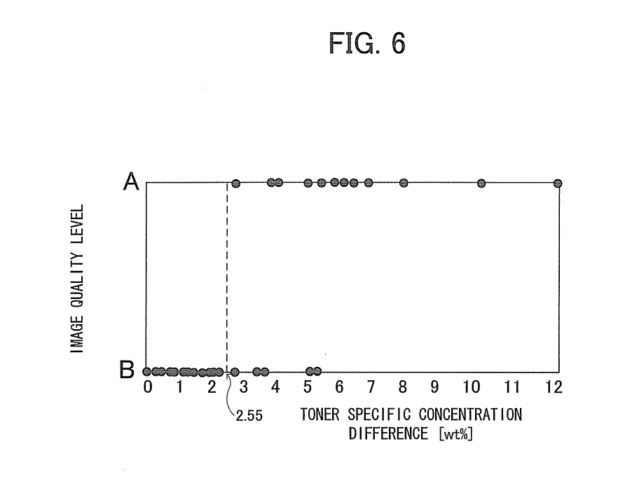

FIG. 6 is a diagram of a relation between a toner specific concentration difference and an image failure in an MFP. The MFP is a color high-speed machine for printing fifty-five or more sheets per minute including a discharge port for discharging a developer deteriorated in the developing device and a toner density sensor provided upstream of the discharge port. The toner density sensor and the discharge port are arranged near each other on the same carrying path. The toner and the carrier are supplied from the developer cartridge into the developing device under a condition that a weight ratio is 6:1. In this case, in this example, the first rotating speed of the mixer 97a2 was set to 358.3 rpm and the first rotating speed of the mixer 97a1 was set to 513.7 rpm. The ordinate of FIG. 6 represents a level of the image failure. A indicates that the image failure occurred. B indicates that the image failure did not occur. The abscissa represents a value of the toner specific concentration difference.

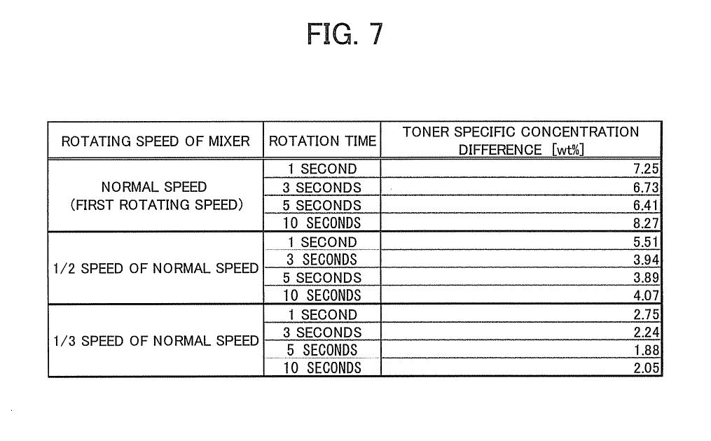

FIG. 7 is a table of a relation between rotating speed of the mixer and the toner specific concentration difference in an MFP under the same condition as FIG. 6.

It can be understood from FIG. 6 that, if the toner specific concentration difference decreases, the image failure less easily occurs. In particular, it is understood that, if the toner specific concentration difference is reduced to be equal to or smaller than 2.55%, the image failure much less easily occurs.

It is understood from FIG. 7 that, if the rotating speed of the mixer is set lower than the first rotating speed, the toner specific concentration difference can be more reduced. In particular, it is understood from FIG. 7 that, by agitating the developer for, for example, 3 to 10 seconds at ⅓ speed of the first rotating speed, the toner specific concentration difference can be reduced to be equal to or smaller than 2.55.

The agitation condition at the second rotating speed is set by also taking into account deterioration of the developer and a discharge amount from the discharge port. In some case, an obtained effect of improvement does not substantially change even if the rotation time of the mixer is set longer than specific time (e.g., five seconds). Therefore, for example, the agitation condition at the second rotating speed can be set to rotate the mixer for three to five seconds at ¼ to ⅓ rotating speed of the first rotating speed. More specifically, the agitation condition can be set to rotate the mixer for three seconds at ⅓ rotating speed of the first rotating speed.

A processing flow related to switching from the first rotating speed to the second rotating speed in the first embodiment is explained.

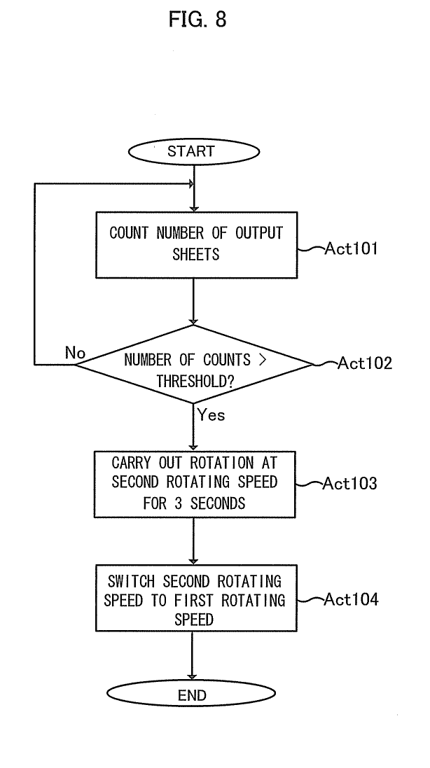

As shown in FIG. 8, first, in Act 101, the number-of-sheets-information acquiring unit 51 counts, on the basis of the log information of the processing for image output to a sheet stored in the memory 803, the number of sheets to which an image is output in the MFP. The number-of-sheets-information acquiring unit 51 generates and acquires number-of-sheets information on the basis of the counted number of sheets and the existing number-of-sheets information (or on the basis of the counted number of sheets). The number-of-sheets-information acquiring unit 51 causes the memory 803 to store the acquired number-of-sheets information and sends the number-of-sheets information to the determining unit 53.

In Act 102, the determining unit 53 determines, using the acquired number-of-sheets information and the threshold information, whether the number of output sheets reaches a threshold of the number of output sheets. If the determining unit 53 determines that the number of output sheets does not reach the threshold, the MFP returns to Act 101 and continues the processing. On the other hand, if the determining unit 53 determines in Act 102 that the number of output sheets reaches the threshold, the determining unit 53 notifies, besides the image-output control unit 52, the agitation control unit 55 of a determination result.

In Act 103, when the agitation control unit 55 acquires the notification of the determination result from the determining unit 53, the agitation control unit 55 switching the rotating speed of the mixer from the first rotating speed to the second rotating speed. Specifically, the agitation control unit 55 acquires, according to the acquisition of the notification from the determining unit 53, the second agitation condition information from the memory 803. Subsequently, as the rotation at the second rotating speed, the agitation control unit 55 rotates, on the basis of the acquired second agitation condition information, the mixer in the developing device for three seconds, for example, at ⅓ speed of the first rotating speed.

After executing the rotation for three seconds at the second rotating speed, in Act 104, the agitation control unit 55 switches the rotating speed from the second rotating speed to the first rotating speed. The agitation control unit 55 notifies, besides the image-output control unit 52, the number-of-sheets-information acquiring unit 51 that the rotating speed is switched from the second rotating speed to the first rotating speed. The number-of-sheets-information acquiring unit 51 deletes, according to the notification from the agitation control unit 55, the number-of-sheets information stored in the memory 803 and starts counting anew.

As explained above, according to the first embodiment, occurrence of a toner lump can be suppressed or an occurred toner lump can be eliminated or occurrence of a toner lump can be suppressed and an occurred toner lump can be eliminated by rotating the mixer at the second rotating speed. Therefore, it is possible to improve the quality of an image formed by the image output processing.

### Second Embodiment

A second embodiment is explained below. Components same as those in the first embodiment are denoted by the same reference numerals and signs and explanation of the components is omitted.

As in the first embodiment, the number-of-sheets-information acquiring unit 51 generates and acquires number-of-sheets information on the basis of a counted number of sheets and existing number-of-sheets information (or on the basis of the counted number of sheets), causes the memory 803 to store the acquired number-of-sheets information, and sends the acquired number-of-sheets information to the determining unit 53.

In the second embodiment, the number-of-sheets-information acquiring unit 51 counts, separately for each of a monochrome mode and a color mode, the number of sheets output by image output processing. In other words, the number-of-sheets-information acquiring unit 51 distinguishes and counts the number of sheets output in the monochrome mode and the number of sheets output in the color mode in the image output processing performed once. The number-of-sheets-information acquiring unit 51 generates and acquires number-of-sheets information separately for each of the monochrome mode and the color mode.

In the second embodiment, the number-of-sheets information in the color mode is information indicating the number of sheets output by execution of the processing for image output to a sheet in the color mode after the last switching from the first rotating speed to the second rotating speed is executed in developing devices corresponding to the color mode. Similarly, the number-of-sheets information in the monochrome mode is information indicating the number of sheets output by execution of the processing for image output to a sheet in the monochrome mode after the last switching from the first rotating speed to the second rotating speed is executed in a developing device corresponding to the monochrome mode. In some case, both the image output processing in the color mode and the image output processing in the monochrome mode are executed in one job.

The number-of-sheets-information acquiring unit 51 causes the memory 803 to store the acquired number-of-sheets information and sends the acquired number-of-sheets information to the determining unit 53. In the second embodiment, the number-of-sheets-information acquiring unit 51 notifies the determining unit 53, in the delivery of the number-of-sheets information, which of the monochrome mode and the color mode the number-of-sheets information to be sent relates to (notification of a mode).

The determining unit 53 determines, using threshold information for each of the monochrome mode and the color mode, whether the number of output sheets acquired by the number-of-sheets-information acquiring unit 51 reaches a threshold of the number of output sheets. The determining unit 53 determines, on the basis of the notification of the mode acquired from the number-of-sheets-information acquiring unit 51, which of the monochrome mode and the color mode a determination result relates to and notifies the agitation control unit 55 of the determination result (notification of a mode determination result).

The agitation control unit 55 switches, on the basis of the notification of the acquired determination result and mode determination result, rotating speed of a mixer arranged in the developing device from the first rotating speed to the second rotating speed. In the second embodiment, the agitation control unit 55 executes switching from the first rotating speed to the second rotating speed concerning rotating speed of mixers of the developing devices corresponding to the color mode in which the number of output sheets is determined as reaching the threshold.

A processing flow related to the switching from the first rotating speed to the second rotating speed in the second embodiment is explained below.

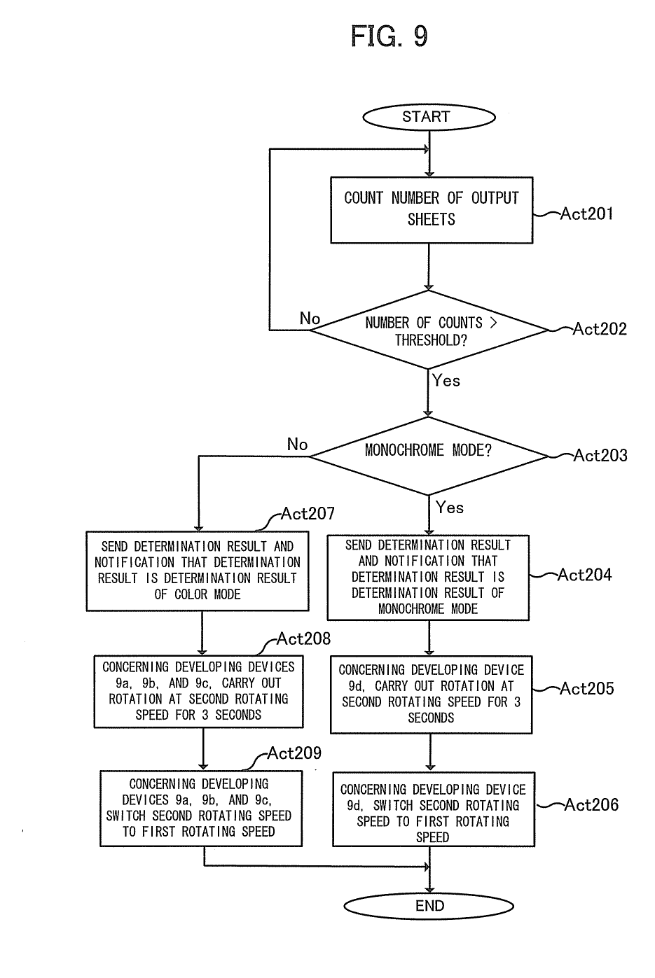

As shown in FIG. 9, first, in Act 201, the number-of-sheets-information acquiring unit 51 counts, on the basis of the log information of the image output processing stored in the memory 803, separately for each of the monochrome mode and the color mode, the number of sheets to which an image is output by the execution of the image output processing in the MFP and obtains information concerning the number of output sheets. Subsequently, the number-of-sheets-information acquiring unit 51 generates and acquires, for each of the monochrome mode and the color mode, number-of-sheets information on the basis of the information concerning the counted number of sheets and the existing number-of-sheets information and causes the memory 803 to store the number-of-sheets information. The number-of-sheets-information acquiring unit 51 sends the number-of-sheets information to the determining unit 53 together with notification of a mode.

In Act 202, the determining unit 53 determines, according to the acquisition of the number-of-sheets information, whether the number of output sheets reaches a threshold of the number of output sheets. If the determining unit 53 determines that the number of output sheets does not reach the threshold, the MFP returns to Act 101 and continues the processing. On the other hand, if the determining unit 53 determines in Act 202 that the number of output sheets reaches the threshold, the determining unit 53 determines, on the basis of the notification of the mode acquired together with the number-of-sheets information, whether it is in the monochrome mode that the number of output sheets is determined as reaching the threshold (Act 203). If the determining unit 53 determines in Act 203 that it is in the monochrome mode that the number of output sheets is determined as reaching the threshold, the determining unit 53 sends notification of a determination result to the image-output control unit 52 and sends the notification of the determination result and notification of a mode determination result indicating that the determination result is a determination result concerning the monochrome mode to the agitation control unit 55 (Act 204). In Act 205, the agitation control unit 55 switches, according to the notification from the determining unit 53, rotating speed from the first rotating speed to the second rotating speed (⅓ speed of the first rotating speed) concerning the developing device 9d, which is a developing device corresponding to the monochrome mode. After executing rotation of the mixer for three seconds at the second rotating speed, in Act 206, the agitation control unit 55 switches the rotating speed of the developing device 9d from the second rotating speed to the first rotating speed. The agitation control unit 55 notifies, besides the image-output control unit 52, the number-of-sheets-information acquiring unit 51 that the rotating speed of the mixer in the developing device corresponding to the monochrome mode is switched from the second rotating speed to the first rotating speed. The number-of-sheets-information acquiring unit 51 deletes, according to the notification from the agitation control unit 55, the number-of-sheets information concerning the monochrome mode stored in the memory 803 and starts counting anew.

If the determining unit 53 determines in Act 203 that it is in the color mode that the number of output sheets is determined as reaching the threshold, the determining unit 53 sends notification of a determination result to the image-output control unit 52 and sends the notification of the determination result and notification of a mode determination result indicating that the determination result is a determination result concerning the color mode to the agitation control unit 55 (Act 207). In Act 208, the agitation control unit 55 switches, concerning the developing devices 9a, 9b, and 9c, which are developing devices corresponding to the color mode, rotating speed of mixers respectively arranged in the developing devices from the first rotating speed to the second rotating speed. After rotating the mixers for three seconds at the second rotating speed, in Act 209, the agitation control unit 55 switches the rotating speed of the mixers in the developing devices 9a, 9b, and 9c from the second rotating speed to the first rotating speed. The agitation control unit 55 notifies, besides the image-output control unit 52, the number-of-sheets-information acquiring unit 51 that the rotating speed of the mixers in the developing devices corresponding to the color mode is switched from the second rotating speed to the first rotating speed. The number-of-sheets-information acquiring unit 51 deletes, according to the notification from the agitation control unit 55, the number-of-sheets information concerning the color mode stored in the memory 803 and starts counting anew.

In the MFP, in some case, a frequency of execution of the processing for image output to a sheet is different in the monochrome mode and the color mode and, as a result, likelihood of occurrence of a toner lump is different in each of developing devices. According to the second embodiment, it is possible to, for example, suppress occurrence of a toner lump and suppress deterioration of a developer by executing agitation at the second rotating speed for each of the monochrome mode and the color mode.

### Third Embodiment

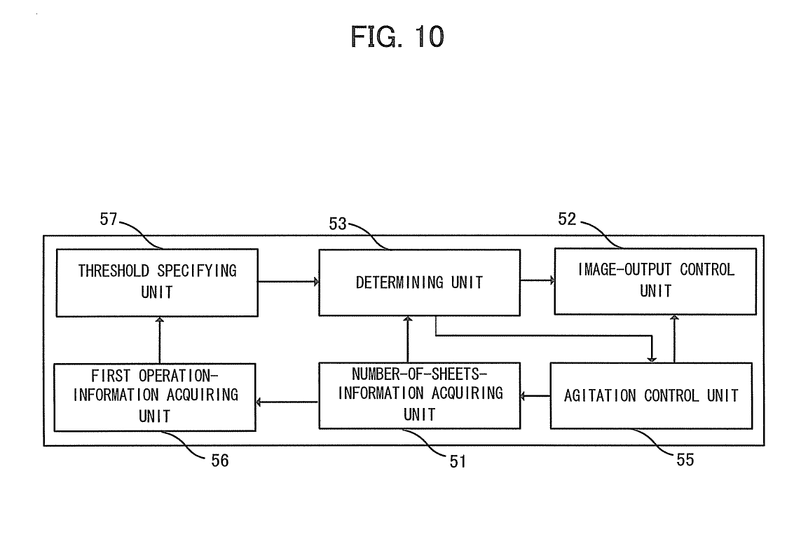

As shown in FIG. 10, in a third embodiment, the MFP includes, in addition to the functional blocks explained in the first embodiment, a first operation-information acquiring unit 56 and a threshold specifying unit 57.

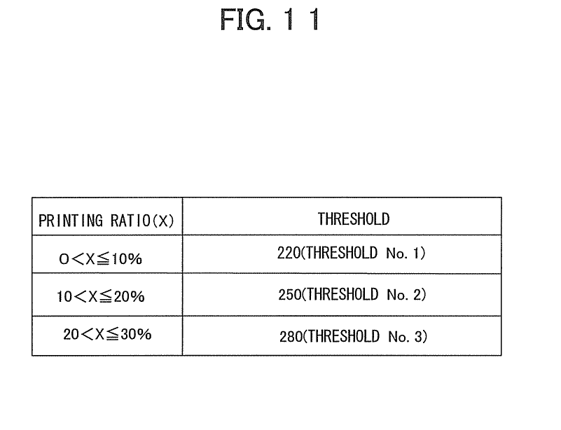

In the third embodiment, for example, as shown in FIG. 11, plural kinds of threshold information are stored in the memory 803. The plural kinds of threshold information are stored in association with ranges of values of an average printing ratio, which is a predetermined reference decided in advance.

The average printing ratio is, if a total area on which an image is formed (equivalent to an area of one sheet) is assume to be 100%, an average of a percentage of an area of a section where a toner is placed. Therefore, it can be said that, as the average printing ratio of an image forming apparatus increases, a toner consumption ratio in the image forming apparatus also increases. In the third embodiment, the CPU 801 acquires, according to execution of image output processing, information concerning the average printing ratio in the MFP (hereinafter referred to as average printing ratio information) using a computer program and causes the memory 803 to store the information.

In the third embodiment, the number-of-sheets-information acquiring unit 51 sends generated number-of-sheets information to the determining unit 53 and notifies the first operation-information acquiring unit 56 that the number-of-sheets information is generated.

The first operation-information acquiring unit 56 acquires the average printing ratio information from the memory 803 according to the acquisition of the notification that the number-of-sheets information is generated. The first operation-information acquiring unit 56 sends the acquired average printing ratio information to the threshold specifying unit 57.

The threshold specifying unit 57 specifies, on the basis of the acquired average printing ratio information, threshold information used for determination by the determining unit 53. Specifically, the threshold specifying unit 57 specifies, on the basis of the average printing ratio information acquired by the first operation-information acquiring unit 56, threshold information, a reference associated with which is satisfied by the average printing ratio, among plural kinds of set threshold information of the number of sheets as the threshold information used by the determining unit 53. Subsequently, the threshold specifying unit 57 notifies the determining unit 53 of the specified threshold information.

The determining unit 53 executes, on the basis of the notification from the threshold specifying unit 57, determination using the threshold information specified by the threshold specifying unit 57.

A processing flow related to switching from first rotating speed to second rotating speed in the third embodiment is explained below.

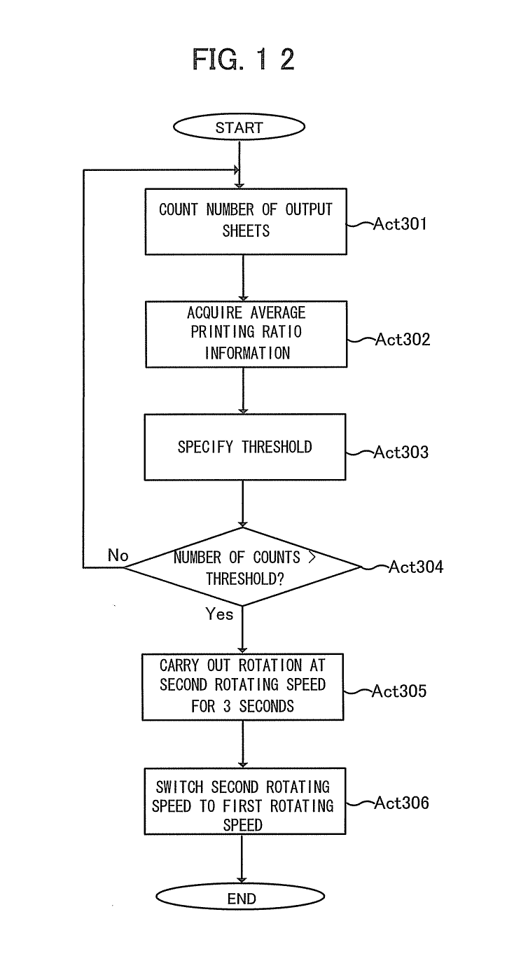

Act 305 and Act 306 shown in FIG. 12 are the same as Act 103 and Act 104 shown in FIG. 8. Therefore, explanation concerning Act 305 and Act 306 is omitted.

In Act 301, the number-of-sheets-information acquiring unit 51 counts, on the basis of the log information of processing for image output to a sheet stored in the memory 803, the number of sheets to which an image is output in the MFP and acquires information concerning the counted number of sheets. The number-of-sheets-information acquiring unit 51 generates number-of-sheets information on the basis of the information concerning the counted number of sheets and existing number-of-sheets information, causes the memory 803 to store the number-of-sheets information, and sends the generated number-of-sheets information to the determining unit 53. Further, in the third embodiment, the number-of-sheets-information acquiring unit 51 notifies the first operation-information acquiring unit 56 that the number-of-sheets information is generated.

In Act 302, the first operation-information acquiring unit 56 acquires average printing ratio information on the basis of the notification that the number-of-sheets information is generated. The first operation-information acquiring unit 56 sends the acquired average printing ratio information to the threshold specifying unit 57.

Subsequently, in Act 303, the threshold specifying unit 57 specifies, using the acquired average printing ratio information, threshold information used by the determining unit 53. More specifically, in the third embodiment, the threshold specifying unit 57 specifies, as the average printing ratio is smaller, threshold information indicating a smaller threshold among the threshold information stored in the memory 803. The threshold specifying unit 57 specifies, as the average printing ratio is larger, threshold information indicating a larger threshold among the threshold information stored in the memory 803. The threshold specifying unit 57 notifies the determining unit 53 of the specified threshold information.

For example, it is assumed that the threshold specifying unit 57 acquires average printing ratio information indicating that an average printing ratio in the MFP is 7%. In this case, the threshold specifying unit 57 specifies a threshold No. 1 (two hundred and twenty) as threshold information used by the determining unit 53. The threshold specifying unit 57 notifies the determining unit 53 that the threshold No. 1 is specified as the threshold information to be used.

In Act 304, the determining unit 53 determines, according to the number-of-sheets information and the acquisition of the notification from the threshold specifying unit 57, whether the number of output sheets reaches a threshold of the number of output sheets using the threshold information specified by the threshold specifying unit 57. If the determining unit 53 determines that the number of output sheets does not reach the threshold, the MFP returns to Act 301 and continues the processing. On the other hand, if the determining unit 53 determines in Act 304 that the number of output sheets reaches the threshold, the determining unit 53 notifies, besides the image-output control unit 52, the agitation control unit 55 of a determination result.

In the MFP, likelihood of occurrence of a toner lump is different according to a difference in the average printing ratio. More specifically, a toner lump is more likely to occur as the average printing ratio is smaller. On the other hand, if the average printing ratio is large, in some case, an amount of toner discharged from the developing device is increased more than necessary when an opportunity for rotating the mixer at the second rotating speed is increased. According to the third embodiment, it is possible to, for example, more efficiently suppress occurrence of a toner lump and suppress the developer from being discharged more than necessary.

### Fourth Embodiment

A fourth embodiment is explained below. Components same as those in the first embodiment are denoted by the same reference numerals and signs and explanation of the components is omitted.

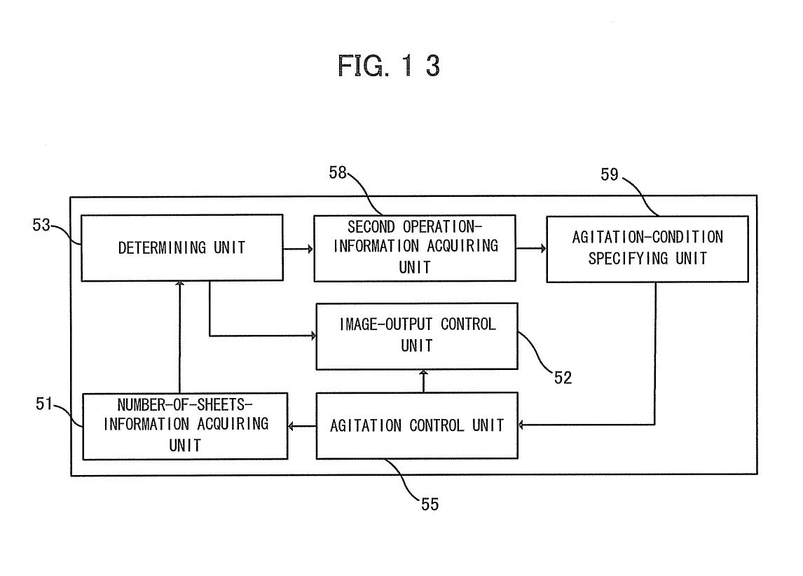

As shown in FIG. 13, in the fourth embodiment, the MFP includes, in addition to the functional blocks explained in the first embodiment, a second operation-information acquiring unit 58 and an agitation-condition specifying unit 59.

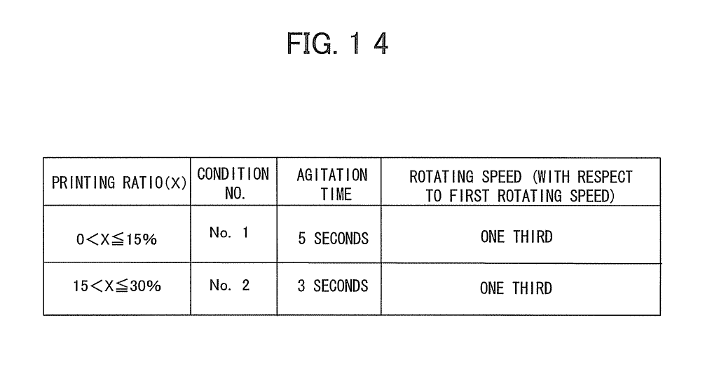

In the fourth embodiment, for example, as shown in FIG. 14, plural kinds of second agitation condition information are stored in the memory 803. The plural kinds of second agitation condition information are stored in association with ranges of values of an average printing ratio, which is a predetermined reference decided in advance.

In the fourth embodiment, if the determining unit 53 determines, on the basis of number-of-sheets information, that the number of output sheets reaches a threshold of the number of output sheets, the determining unit 53 sends notification of a determination result to the second operation-information acquiring unit 58.

The second operation-information acquiring unit 58 acquires average printing ratio information from the memory 803 according to the notification of the determination result from the determining unit 53. The second operation-information acquiring unit 58 sends the acquired average printing ratio information to the agitation-condition specifying unit 59.

The agitation-condition specifying unit 59 specifies, on the basis of the acquired average printing ratio information, second agitation condition information used by the agitation control unit 55. Specifically, the agitation-condition specifying unit 59 specifies, on the basis of the average printing ratio information acquired by the operation-information acquiring unit 58, second agitation condition information, a reference associated with which is satisfied by the average printing ratio of the MFP, among the set plural kinds of second agitation condition information as second agitation condition information used by the agitation control unit 55.

Subsequently, the agitation-condition specifying unit 59 notifies the agitation control unit 55 of the specified second agitation condition information.

The agitation control unit 55 switches, using the second agitation condition information specified by the agitation-condition specifying unit 59, rotation speed of a mixer from first rotating speed to second rotating speed and causes the mixer to execute agitation at the second rotating speed.

A processing flow related to switching from the first rotating speed to the second rotating speed in the fourth embodiment is explained below.

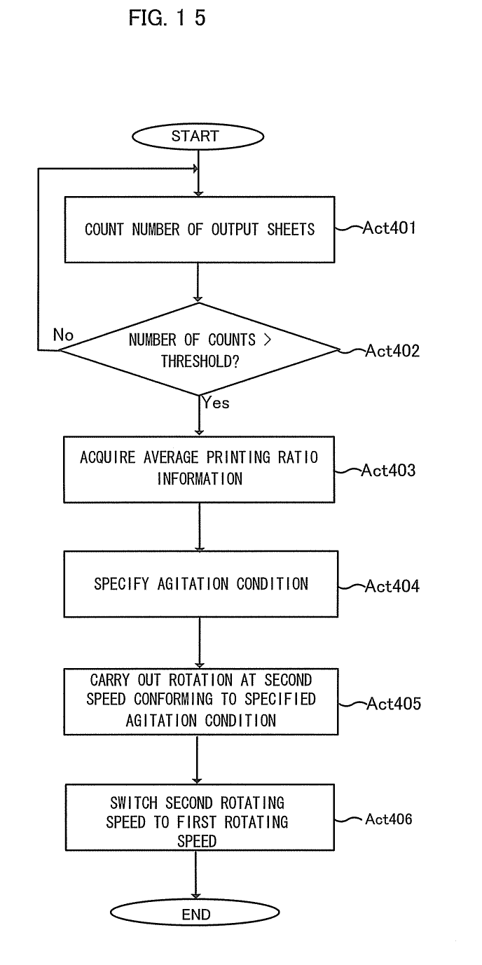

Act 401 to Act 402 shown in FIG. 15 are the same as Act 101 to Act 102 shown in FIG. 8. Act 406 shown in FIG. 15 is common to Act 104 shown in FIG. 8. Therefore, explanation concerning Act 401 to Act 402 and Act 406 is omitted.

In Act 403, the second operation-information acquiring unit 58 acquires average printing ratio information according to the acquisition of the notification of the determination result from the determining unit 53. The second operation-information acquiring unit 58 sends the acquired average printing ratio information to the agitation-condition specifying unit 59.

In Act 404, the agitation-condition specifying unit 59 specifies, using the acquired average printing ratio information, second agitation condition information used by the agitation control unit 55. The agitation-condition specifying unit 59 notifies the agitation control unit 55 of the specified second agitation condition information.

In Act 405, the agitation control unit 55 acquires, on the basis of the notification from the agitation-condition specifying unit 59, the second agitation condition information specified by the agitation-condition specifying unit 59 from the memory 803. The agitation control unit 55 switches, using the acquired second agitation condition information, the first rotating speed to the second rotating speed and causes the mixer to execute rotation.

For example, it is assumed that the agitation-condition specifying unit 59 acquires information indicating that an average printing ratio in the MFP is 8%. In this case, the agitation-condition specifying unit 59 specifies agitation condition No. 1 that satisfies a range of an average printing ratio associated as the second agitation condition information used by the agitation control unit 55. The agitation-condition specifying unit 59 notifies the agitation control unit 55 that the agitation condition No. 1 is specified as the second agitation condition information to be used. The agitation control unit 55 switches, on the basis of the agitation condition No. 1, the rotating speed of the mixer from the first rotating speed to the second rotating speed, which is ⅓ speed of the first rotating speed, and causes the mixer to execute agitation at the second rotating speed for five seconds.

Specifically, in the fourth embodiment, the agitation-condition specifying unit 59 specifies, as the average printing ratio is smaller, an agitation condition with longer rotation time of the mixer among agitation conditions stored in the memory 803 as an agitation condition used by the agitation control unit 55. The agitation-condition specifying unit 59 specifies, as the average printing ratio is larger, an agitation condition with shorter agitation time among the agitation conditions stored in the memory 803 as an agitation condition used by the agitation control unit 55.

In the MFP, likelihood of occurrence of a toner lump is different according to a difference in the average printing ratio. More specifically, a toner lump is more likely to occur as the average printing ratio is smaller. On the other hand, if the average printing ratio is large, in some case, an amount of toner discharged from the developing device is increased more than necessary when time in which the mixer is rotated at the second rotating speed is increased. According to the fourth embodiment, it is possible to, for example, more efficiently suppress occurrence of a toner lump and suppress the developer from being discharged more than necessary.

The first to fourth embodiments are explained above. However, it is naturally also possible to adopt other forms.

For example, in the third and fourth embodiments, the threshold of the number of counted sheets or the agitation condition at the second rotating speed is specified on the basis of the average printing ratio of the MFP. However, the present invention is not limited to this. It is naturally also possible to adopt other forms. For example, in the forms explained as the third and fourth embodiments, the first operation-information acquiring unit 56 and the second operation-information acquiring unit 58 may acquire information concerning an average intermittence ratio (an average of ratios indicating for how long time the developing device is stopped (or driven) in a certain period), which is a ratio indicating an operation frequency of the developing device and humidity in the developing device. The information concerning the average intermittence ratio can be acquired from the memory 803 in the same manner as the average printing ratio. The humidity in the developing device can be acquired via the humidity sensor S arranged in the developing device.

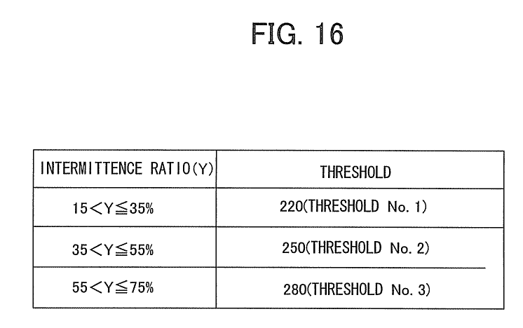

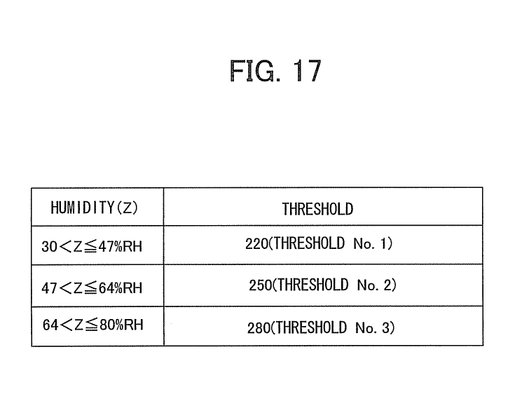

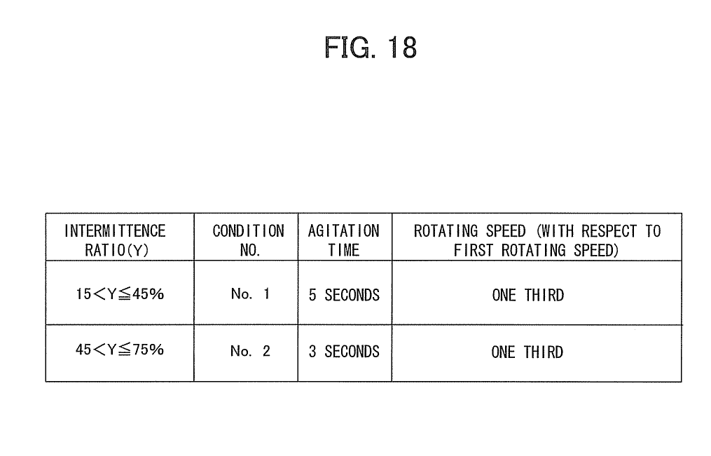

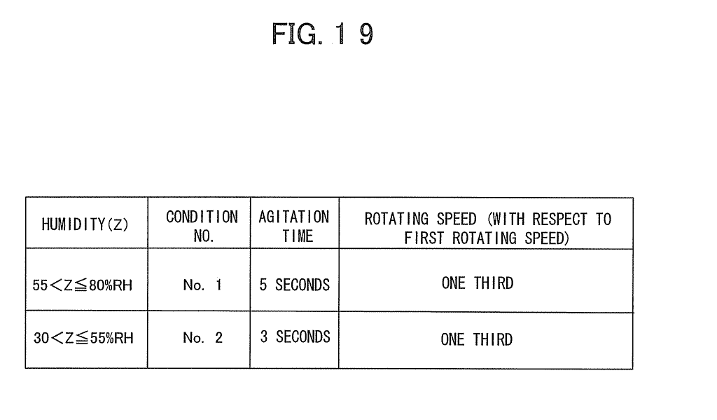

As in the third and fourth embodiments, the threshold specifying unit 57 may specify, on the basis of the acquired information concerning the average intermittence ratio and the humidity in the developing device, thresholds associated with references of the average intermittence ratio and the humidity in the developing device as shown in FIGS. 16 and 17. In this case, for example, the threshold specifying unit 57 may specify, as the average intermittence ratio is smaller, threshold information indicating a smaller threshold among the threshold information stored in the memory 803. The threshold specifying unit 57 may specify, as the humidity in the developing device is higher, threshold information indicating a smaller threshold among the threshold information stored in the memory 803. As in the third and fourth embodiments, the agitation-condition specifying unit 59 may specify, on the basis of the acquired information concerning the average intermittence ratio and the humidity in the developing device, second agitation condition information associated with references of the average intermittence ratio and the humidity in the developing device as shown in FIGS. 18 and 19. In this case, for example, the agitation-condition specifying unit 59 may specify, as the average intermittence ratio is smaller, an agitation condition with longer agitation time among the agitation conditions stored in the memory 803 as an agitation condition used by the agitation control unit 55. The agitation-condition specifying unit 59 may specify, as the humidity in the developing device is higher, an agitation condition with longer agitation time among the agitation conditions stored in the memory 803 as an agitation condition used by the agitation control unit 55.

To facilitate understanding, in the third and fourth embodiments, the embodiments are explained as forms in which the monochrome mode and the color mode are not distinguished on the basis of the first embodiment. However, the present invention is not limited to this. As in the second embodiment, the number of sheets may be counted for each of the monochrome mode and the color mode.

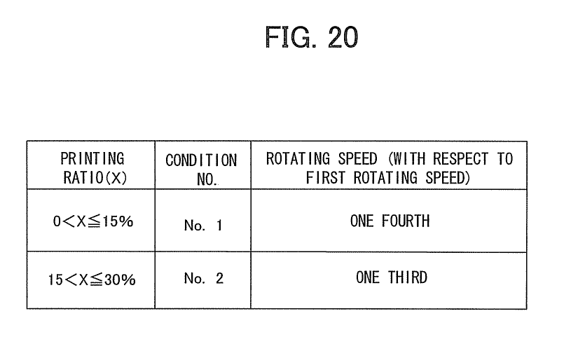

Further, in the fourth embodiment, an example in which time for rotating the mixer at the second rotating speed is changed according to the average printing ratio of the MFP is explained. However, the present invention is not limited to this form. For example, speed corresponding to the second rotating speed may be changed according to a printing ratio. Specifically, as shown in FIG. 20, as another form, if the average printing ratio is smaller than a predetermined reference, rotating speed can be set lower.

Further, in the second embodiment, the same threshold is used between the monochrome mode and the color mode. However, the present invention is not limited to this. For example, different thresholds may be used between the monochrome mode and the color mode.

In the first to fourth embodiments, if the number of sheets output after the last switching from the first rotating speed to the second rotating speed is performed reaches the predetermined threshold, the switching from the first rotating speed to the second rotating speed is performed. However, the present invention is not limited to this. For example, in alternative embodiment, the switching from the first rotating speed to the second rotating speed may be performed based on other information indicating the quantity of the image output processing, such as information indicating the rotation number of a photoconductive drum. Specifically, if the rotation number of a photoconductive drum after the last switching from the first rotating speed to the second rotating speed is performed reaches the predetermined threshold, the switching from the first rotating speed to the second rotating speed is performed.

In further alternative embodiment, the switching from the first rotating speed to the second rotating speed may be performed if the number of revolutions of the mixer in the developing device reaches a predetermined threshold after the last switching from the first rotating speed to the second rotating speed. The switching from the first rotating speed to the second rotating speed may be performed if resistance applied to the mixer by rotation reaches a predetermined threshold. Further, the switching from the first rotating speed to the second rotating speed may be performed if driving time of a motor for rotating the mixer reaches a predetermined threshold.

A computer program for causing a computer included in the image forming apparatus to execute the operations explained above can be provided as an agitation control program for the developing device. In the example explained in the embodiments, the computer program for realizing the functions for carrying out the invention is recorded in advance in a storage area provided in the apparatus. However, the present invention is not limited to this. The same program may be downloaded from a network to the apparatus or the same program stored in a computer-readable recording medium may be installed in the apparatus. A form of the recording medium may be any form as long as the recording medium can store a computer program and is computer-readable. Specifically, examples of the recording medium include internal storage devices internally mounted on a computer such as a ROM and a RAM, portable storage media such as a CD-ROM, a flexible disk, a DVD disk, a magneto-optical disk, and an IC card, a database that stores a computer program, other computers and databases of the computers, and transmission media on a line. Functions obtained by the installation and the download in this way may be realized in cooperation with an OS (operating system) or the like in the apparatus.

The computer program may be an execution module dynamically generated partially or entirely.

It goes without saying that it is also possible to cause the ASIC 802 to execute, in terms of a circuit, at least a part of the various kinds of processing realized by causing a processor (e.g., the CPU 801) to execute the computer program in the embodiments.

While certain embodiments have been described, these embodiments have been presented by way of example only, and are not intended to limit the scope of invention. Indeed, the novel apparatus, methods and computer readable media described herein may be embodied in a variety of other forms; furthermore, various omissions, substitutions and changes in the form of the apparatus and methods and computer readable media described herein may be made without departing from the sprit of the inventions. The accompanying claims and their equivalents are intended to cover such forms or modifications as would fall within the scope and spirit of the inventions.

As explained above in detail, according to the technique described in this specification, it is possible to provide a technique that can improve the quality of an image formed by the image output processing.

What is claimed is:

1. An image forming apparatus comprising:
a developing device configured to store developer containing a toner and a carrier and to discharge a part of the stored developer;
a supply unit configured to supply the developer to the developing device;
a mixer arranged in the developing device and configured to rotate at first rotating speed or second rotating speed lower than the first rotating speed and agitate the developer;
a information acquiring unit configured to acquire information indicating quantity of image output processing;
a determining unit configured to determine, on the basis of the information acquired by the information acquiring unit, whether the quantity of image output processing reaches a predetermined threshold; and
an agitation control unit configured to change, if the determining unit determines that the quantity of output processing reaches the threshold, rotating speed of the mixer executed at the first rotating speed to the second rotating speed.

2. An image forming apparatus comprising:
a developing device configured to store, on an inside, a developer containing a toner and a carrier and discharge a part of the stored developer;
a supply unit configured to supply the developer to the developing device;
a mixer arranged in the developing device and configured to rotate at first rotating speed or second rotating speed lower than the first rotating speed and agitate the developer;
a number-of-sheets-information acquiring unit configured to acquire number-of-sheets information, which is information indicating a number of sheets output by execution of image output processing;
a determining unit configured to determine, on the basis of the number-of-sheets information acquired by the number-of-sheets-information acquiring unit, whether the number of output sheets reaches a predetermined threshold; and
an agitation control unit configured to switch, if the determining unit determines that the number of output sheets reaches the threshold, rotating speed of the mixer executed at the first rotating speed to the second rotating speed.

3. The apparatus according to claim 2, wherein the agitation control unit switches, after rotating the mixer for a predetermined time at the second rotating speed, the rotating speed of the mixer from the second rotating speed to the first rotating speed.

4. The apparatus according to claim 2, further comprising an image-output control unit configured to control start timing for the execution of the image output processing in the apparatus, wherein
the agitation control unit switches, if the determining unit determines that the number of output sheets reaches the threshold, the rotating speed of the mixer from the first rotating speed to the second rotating speed and causes the mixer to execute rotation at the second rotating speed for a predetermined time, and
the image-output control unit disables the execution of the image output processing while the mixer is rotated at the second rotating speed.

5. The apparatus according to claim 2, wherein the mixer rotates at the first rotating speed when the image output processing is executed in the apparatus.

6. The apparatus according to claim 2, wherein
the apparatus is executing the image output processing in a monochrome mode or a color mode,
the number-of-sheets-information acquiring unit acquires the number-of-sheets information separately for each of the monochrome mode and the color mode,
the determining unit determines, separately for each of the monochrome mode and the color mode, on the basis of the number-of-sheets information acquired by the number-of-sheets-information acquiring unit separately for each of the monochrome mode and the color mode, whether the number of output sheets reaches the threshold, and
the agitation control unit switches the rotating speed of the mixer, which is arranged in the developing device corresponding to a mode in which the number of output sheets is determined as reaching the threshold of the number of output sheets by the determining unit, from the first rotating speed to the second rotating speed.

7. The apparatus according to claim 2, wherein the agitation control unit rotates, if the determining unit determines that the number of output sheets reaches the threshold, the mixer for three to five seconds at the second rotating speed, which is ¼ to ⅓ speed of the first rotating speed.

8. The apparatus according to claim 2, wherein
a plurality of the thresholds are set and each of the plural thresholds is associated with a reference decided in advance concerning an average printing ratio in the apparatus, an average intermittence ratio indicating an operation frequency of the developing device, or humidity in the developing device,
the apparatus further comprises:
an operation-information acquiring unit configured to acquire information concerning the average printing ratio, the average intermittence ratio, or the humidity; and
a threshold specifying unit configured to specify, on the basis of the information concerning the average printing ratio, the average intermittence ratio, or the humidity acquired by the operation-information acquiring unit, the threshold satisfying the reference associated with the average printing ratio, the average intermittence ratio, or the humidity among the set plural thresholds as the threshold used by the determining unit.

9. The apparatus according to claim 2, wherein
a plurality of the thresholds are set and each of the plural thresholds is associated with a reference decided in advance concerning an average printing ratio in the apparatus,
the apparatus further comprises:
an operation-information acquiring unit configured to acquire information concerning the average printing ratio; and
a threshold specifying unit configured to specify, on the basis of the information concerning the average printing ratio acquired by the operation-information acquiring unit and the reference, the threshold having a smaller value as the average printing ratio is smaller among the set plural thresholds as the threshold used by the determining unit.

10. The apparatus according to claim 2, wherein
a plurality of the thresholds are set and each of the plural thresholds is associated with a reference decided in advance concerning an average intermittence ratio indicating an operation frequency of the developing device,
the apparatus further comprises:
an operation-information acquiring unit configured to acquire information concerning the average intermittence ratio; and
a threshold specifying unit configured to specify, on the basis of the information concerning the average intermittence ratio acquired by the operation-information acquiring unit and the reference, the threshold having a smaller value as the average intermittence ratio is smaller among the set plural thresholds as the threshold used by the determining unit.

11. The apparatus according to claim 2, wherein
a plurality of the thresholds are set and each of the plural thresholds is associated with a reference decided in advance concerning humidity in the developing device,
the apparatus further comprises:
an operation-information acquiring unit configured to acquire information concerning the humidity; and
a threshold specifying unit configured to specify, on the basis of the information concerning the humidity acquired by the operation-information acquiring unit and the reference, the threshold having a smaller value as the humidity is higher among the set plural thresholds as the threshold used by the determining unit.

12. The apparatus according to claim 2, wherein
the agitation at the second rotating speed is executed on the basis of an agitation condition at the second rotating speed, and a plurality of the agitation conditions are set and each of the plural agitation conditions is associated with a reference decided in advance concerning an average printing ratio in the apparatus, an average intermittence ratio indicating an operation frequency of the developing device, or humidity in the developing device,
the apparatus further comprises:
an operation-information acquiring unit configured to acquire information concerning the average printing ratio, the average intermittence ratio, or the humidity; and
an agitation-condition specifying unit configured to specify, on the basis of the information concerning the average printing ratio, the average intermittence ratio, or the humidity acquired by the operation-information acquiring unit, the agitation condition satisfying the reference associated with the average printing ratio, the average intermittence ratio, or the humidity among the set plural agitation conditions as the agitation condition used by the agitation control unit.

13. The apparatus according to claim 2, wherein
the agitation at the second rotating speed is executed on the basis of an agitation condition at the second rotating speed including agitation time, and a plurality of the agitation conditions are set and each of the plural agitation conditions is associated with a reference decided in advance concerning an average printing ratio in the apparatus,
the apparatus further comprises:
an operation-information acquiring unit configured to acquire information concerning the average printing ratio; and
an agitation-condition specifying unit configured to specify, on the basis of the information concerning the average printing ratio acquired by the operation-information acquiring unit and the reference, the agitation condition set to longer agitation time as the average printing ratio is smaller among the set plural agitation conditions as the agitation condition used by the agitation control unit.

14. The apparatus according to claim 2, wherein
the agitation at the second rotating speed is executed on the basis of an agitation condition at the second rotating speed including agitation time, and a plurality of the agitation conditions are set and each of the plural agitation conditions is associated with a reference decided in advance concerning an average intermittence ratio indicating an operation frequency of the developing device,
the apparatus further comprises:
an operation-information acquiring unit configured to acquire information concerning the average intermittence ratio; and
an agitation-condition specifying unit configured to specify, on the basis of the information concerning the average intermittence ratio acquired by the operation-information acquiring unit and the reference, the agitation condition set to longer agitation time as the average intermittence ratio is smaller among the set plural agitation conditions as the agitation condition used by the agitation control unit.

15. The apparatus according to claim 2, wherein
the agitation at the second rotating speed is executed on the basis of an agitation condition at the second rotating speed including agitation time, and a plurality of the agitation conditions are set and each of the plural agitation conditions is associated with a reference decided in advance concerning humidity in the developing device,
the apparatus further comprises:
an operation-information acquiring unit configured to acquire information concerning the humidity; and
an agitation-condition specifying unit configured to specify, on the basis of the information concerning the humidity acquired by the operation-information acquiring unit and the reference, the agitation condition set to longer agitation time as the humidity is higher among the set plural agitation conditions as the agitation condition used by the agitation control unit.

16. An agitation controlling method for a developing device in an image forming apparatus including: a developing device configured to store, on an inside, a developer containing a toner and a carrier and discharge a part of the stored developer; a supply unit configured to supply the developer to the developing device; and a mixer arranged in the developing device and configured to rotate at first rotating speed or second rotating speed lower than the first rotating speed and agitate the developer, the method comprising:
acquiring information indicating quantity of image output processing;
determining, on the basis of the acquired information indicating the quantity of image output processing, whether the quantity of image output processing reaches a predetermined threshold; and
switching, if it is determined that the quantity of image output processing reaches the threshold, rotating speed of the mixer executed at the first rotating speed to the second rotating speed.

17. The method according to claim 16, wherein the switching the rotating speed is switching, after rotating the mixer for a predetermined time at the second rotating speed, the rotating speed of the mixer from the second rotating speed to the first rotating speed.

18. The method according to claim 16, further comprising:
controlling start timing for the execution of the image output processing in the image forming apparatus;
switching, if it is determined that the quantity of image output processing reaches the threshold, the rotating speed of the mixer from the first rotating speed to the second rotating speed and causing the mixer to execute rotation at the second rotating speed for a predetermined time; and
disabling the execution of the image output processing while the mixer is rotated at the second rotating speed.

19. The method according to claim 16, wherein the mixer rotates at the first rotating speed when the image output processing is executed in the image forming apparatus.

20. The method according to claim 16, wherein
the image forming apparatus is executing the image output processing in a monochrome mode or a color mode, and
the method further comprises:
acquiring the information indicating the quantity of image output processing separately for each of the monochrome mode and the color mode;
determining, separately for each of the monochrome mode and the color mode, on the basis of the acquired information indicating the quantity of image output processing separate for each of the monochrome mode and the color mode, whether the quantity of image output processing reaches the threshold; and
switching the rotating speed of the mixer, which is arranged in the developing device corresponding to a mode in which the quantity of image output processing is determined as reaching the threshold of the quantity of image output processing, from the first rotating speed to the second rotating speed.

21. The method according to claim 16, further comprising rotating, if it is determined that the quantity of image output processing reaches the threshold, the mixer for three to five seconds at the second rotating speed, which is ¼ to ⅓ speed of the first rotating speed.
